(19) United States
(12) Patent Application Publication
(10) Pub. No.: US 2006/0289564 A1
(43) Pub. Date: Dec. 28, 2006

(54) Foam generating and injecting apparatus

(75) Inventor: Richard A. Porter, Knoxville, TN (US)

Correspondence Address: MICHAEL E. MCKEE;Attorney at Law, 804 Swaps Lane, Knoxville, TN, 37923, US

(73) Assignee: Core Foam, Inc.

(21) Appl. No.: 11/158,810

(22) Filed: Jun. 22, 2005

(51) Int. Cl. B67D 5/60

(52) U.S. Cl. 222/145.7

(57) ABSTRACT

An apparatus for generating and injecting a foamed polymeric resin formed by the mixture of a plurality of liquid foam-producing ingredients delivered to the apparatus from sources of foam-producing ingredients and including a manifold section into which the liquid foam-producing ingredients are introduced to the apparatus also includes a plurality of digital flow meters for monitoring the flow of each liquid foam-producing ingredient delivered to the manifold section and adjustable needle valves for controllably regulating the flow of each liquid foam-producing ingredient into the manifold section between two preselected flow rates to thereby accurately control the flow of liquid foam-producing ingredients introduced to the apparatus.

### BACKGROUND OF THE INVENTION

This invention relates generally to apparatus for generating and injecting a foamed polymeric resin produced with foam-producing ingredients delivered to the apparatus and relates, more particularly, to the control of the foam-producing ingredients directed through the apparatus. Foamed polymeric resins have been found to be particularly well-suited for use as a thermal and/or acoustical insulation.

The apparatus with which this invention is concerned is in the form of an elongated foam, or spray, gun having a manifold section at one end of the gun through which foam-producing ingredients are introduced to the gun and a nozzle section at the opposite end of the gun through which the generated foam is discharged from the gun. The foam-producing ingredients used to generate a foam within the gun include a liquid solution of resin, a liquid solution of foaming catalyst and a compressed gas (e.g. air), and each ingredient is introduced to the gun through the manifold section thereof and forced to mix with the other ingredients as they are forced to flow toward the opposite, nozzle, end of the gun.

An example of a foam, or spray, gun which accepts foam-producing ingredients for generating foamed polymeric resin in the manner described above is shown and described in U.S. Pat. No. 4,213,936, the disclosure of which is incorporated herein by reference.

At a jobsite (at which the generated foam is injected in place for insulative purposes), an air compressor and associated equipment for delivering the foam-producing ingredients (e.g. resin solution, foaming catalyst and compressed air) to the foam gun are commonly mounted upon a parked trailer or truck, and a foam gun, such as is described in the referenced patent, is connected to the air compressor and the associated ingredient-delivering equipment by way of flexible hoses. With the foam gun connected to the air compressor and the ingredient-delivering equipment in this manner, the foam gun can be manually transported between different locations at the jobsite where the foamed plastic resin is desired to be injected or installed.

To ensure that the quality of the foamed polymeric resin generated with the foam gun is satisfactory, it is desirable that the foam-producing ingredients are mixed together within the foam gun in predetermined ingredient-to-ingredient ratios. Otherwise, the resulting foamed resin may, for example, be too resin-rich or too resin-poor and therefore fail to provide the insulative properties desired and, in some cases, can result in foamed resin that imparts a resin-rich stain or a foaming-catalyst-rich stain to a wall structure within which the foam ingredients are injected or can result in severe foam shrinkage (as in the case of foaming catalyst-rich-material) or poor product coverage or yield (as in the case of resin-rich foamed polymeric resin).

It will therefore be understood that unless the foam ingredients are mixed or blended in a predetermined ingredient-to-ingredient ratio, undesirable consequences can result. Examples of a resin solution and a foaming agent available from the assignee of the present invention are preferably mixed together with compressed gas (e.g. air) in a one-to-one ratio to form the desired foamed resin.

A commonly-utilized method of monitoring the ratio of foam-producing ingredients being injected into place involves the monitoring of the level of ingredients remaining within the containers (e.g. tanks) from which the ingredients are being withdrawn. For example, if the desired ratio of a resin solution to foaming solution in a foamed polymeric resin is one-to-one and the rate at which such foam-producing ingredients being withdrawn from the containers is about equal, it is presumed that the ratio of such foam-producing ingredients being mixed at the foam gun is about one-to-one. However, such a method of monitoring the ratio of ingredients being mixed at the foam gun is not known to be very accurate and are time-consuming.

In particular and within conventional foam-generating and injecting systems, the sources of foam-producing ingredients (e.g. an air compressor and reservoirs containing foaming catalyst and resin solution) are commonly equipped with pressure gauges and related flow-control items (e.g. pressure regulators), but these control-related items are disposed remotely of (i.e. far upstream of) the foam gun. Consequently, to monitor or adjust the flow and ratio of the ingredients flowing to the foam gun, an operator must monitor the level of the foam-producing ingredients remaining within the containers (e.g. tanks) and make adjustments, if necessary, to the control-related items at the sources of the foam-producing ingredients—that is to say, remotely of (i.e. far upstream of) the foam gun. Because of the remote disposition of the foam gun to the control-related items, the accuracy of an adjustment in the flow of foam-producing ingredients through the foam gun in response to an adjustment at the sources of the foam-producing ingredients is necessarily delayed until sufficient amounts of ingredients are removed from the containers (e.g. tanks) so that the operator can make a subsequent determination of the ratio of foam-producing ingredients being mixed at the foam gun.

Furthermore, if the operator who must monitor and make appropriate adjustments to the flow control items at a parked truck is also the individual who must operate the foam gun (which is typically the case), then the foam gun operator will necessarily have to travel from a location at which the foamed resin is desired to be injected each time that the reservoir levels and/or flow control items must be checked or adjustments to the flow of ingredients to the foam gun must be made. This method of monitoring the flow of the foam-producing ingredients can be both burdensome and time-consuming.

Furthermore, the portion of the flexible hoses extending between the flow control valves and the foam gun in conventional systems are typically large in capacity. Both the time delay involved between an adjustment in the flow rate of a foam-producing ingredient and a corresponding drop in the reservoir level of the ingredient at the foam truck, along with the relative difficulty in accruately measureing the reservoir levels to determine the precise consumption of each foam-producing ingredient present difficulties in accurately controlling the flow of the various foam-producing ingredients through the foam gun and also allow a portion of the building structure to be insulated with foam of undetermined quality since the ratio of foam ingredients cannot quickly be determined.

Accordingly, it is an object of the present invention to provide a new and improved apparatus of the aforedescribed class which obviates the need for an operator to monitor or make adjustments to the reservoir levels of foam-producing ingredients remote of (i.e. far upstream of) the apparatus.

Another object of the present invention is to provide such an apparatus for accurately monitoring and controlling the flow of foam-producing ingredients through the apparatus.

Still another object of the present invention is to provide such an apparatus which circumvents burdensome and time-consuming difficulties associated with the control of foam-producing ingredients in conventional systems for generating and injecting foamed resin.

Yet another object of the present invention is to provide such a foam gun which is uncomplicated in structure, yet effective in operation.

A further object of the present invention is to provide an improved method of regulating flow of various ones of the foam-producing ingredients.

A still further object of the present invention is to provide such an apparatus including means for monitoring the material flow with a much higher accuracy than can be achieved through the current techniques of visually inspecting tank levels of foam-producing ingredients during a foam-generating process.

### SUMMARY OF THE INVENTION

This invention resides in an improvement in an apparatus for generating and injecting a foamed polymeric resin formed by the mixture of a plurality of foam-producing ingredients delivered to the apparatus from sources of foam-producing ingredients wherein the foam-producing ingredients include liquid ingredients and wherein the apparatus includes a manifold section into which the foam-producing ingredients are introduced to the apparatus.

The improvement includes means for monitoring the flow of at least one liquid foam-producing ingredient introduced to the manifold section of the apparatus and adjustable valving means for controllably regulating the flow of the at least one liquid foam-producing ingredient into the manifold section between two preselected flow rates. Each of the monitoring means and the adjustable valving means are associated with the manifold section of the apparatus so that the flow of the at least one liquid foam-producing ingredient introduced to the manifold section can be monitored and controlled at the apparatus.

### BRIEF DESCRIPTION OF THE DRAWINGS

FIG. 1 is a side elevational view, shown partially in longitudinal cross section, of a foam gun within which features of the present invention are embodied.

FIG. 2 is an end view, as seen from the left in FIG. 1, of the manifold section of the FIG. 1 foam gun.

FIG. 3 is a side elevational view, shown partially in longitudinal cross section, of a fragment of an alternative foam gun within which features of the present invention are embodied.

FIG. 4 is an end view, as seen from the left in FIG. 3, of the manifold section of the FIG. 3 foam gun.

### DETAILED DESCRIPTION OF AN ILLUSTRATIVE EMBODIMENT

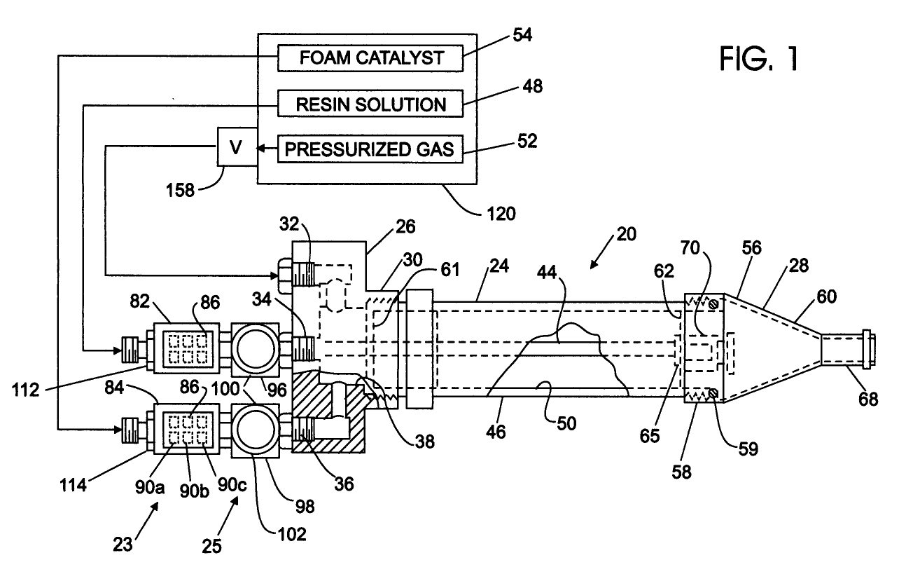

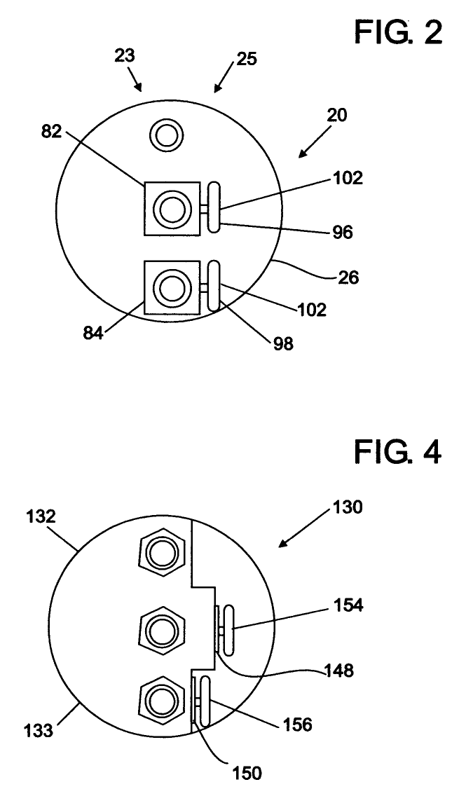

Turning now to the drawings in greater detail and considering first FIGS. 1 and 2, there is illustrated an embodiment, generally indicated 20, of a foam generating and injecting apparatus (hereinafter referred to as a foam gun), within which features of the present invention are embodied. The foam gun 20 is adapted to receive three foam-producing ingredients, namely, a pressurized gas (e.g. air), a liquid solution of resin, and a liquid foaming catalyst, used to generate a foamed polymer resin within the gun 20 for discharge from one end thereof. As will be described in greater detail herein, the foam gun 20 includes means, generally indicated 23, for monitoring the flow of each liquid foam-producing ingredient entering the foam gun 20 and adjustable valving means, generally indicated 25, for controllably regulating the flow of each liquid foam-producing ingredient entering the foam gun 20. By monitoring the flow of each liquid foam-producing ingredient entering the foam gun 20 and providing an operator with the capacity to adjust the flow of each liquid foam-producing ingredient at the gun 20, a desired ratio of foam-producing ingredients can be easily and accurately maintained during operation of gun 20.

With reference still to FIG. 1, the foam gun 20 includes an elongated body 24 having a manifold section 26 disposed at one end of the gun 20 and a nozzle section 28 disposed at the opposite end of the gun 20. The manifold section 26 includes a head 30 having three passageways 32, 34 and 36 through which the three foam-producing ingredients are delivered to the gun 20 and which open to a hollow interior 38.

One passageway, indicated 34 in FIG. 1, is disposed substantially centrally of the head 30 of the manifold section 26, and there exists a central conduit 44 which is joined at one end to the passageway 34 for accepting the contents conducted therethrough and is supported at its other end adjacent the nozzle section 28. The passageway 34 and conduit 44 are adapted to conduct a liquid resin solution delivered, under pressure, to the gun 20 from a source, indicated 48, of liquid resin solution to the nozzle section 28 where it is mixed with the other two foam-producing ingredients (i.e. the compressed gas and foaming catalyst) to generate the desired resin foam.

The other two passageways 32 and 36 provide conduits in the head 30 which are adapted to accept the other two foam-producing ingredients (i.e. compressed gas and foaming catalyst) delivered, respectively, to the foam gun 20 from a compressed gas source 52 (e.g. an air compressor) and a source 54 of liquid foaming catalyst. The gun 20 further includes a cylindrical tube 46 which is threadably joined to the head 30 so that the interior of the tube 46 is in communication with the hollow interior 38 of the head 30. Consequently, the compressed gas and foaming catalyst which are delivered to the gun 20 by way of the passageways 32 and 36 are forced to flow through the tube 46 toward the nozzle section 28. As the foaming catalyst and gas are directed through the tube 46, the foaming catalyst and gas mix with one another to form a foamy substance comprised of spherical bubbles of gas surrounded by a film layer of liquid foaming catalyst. The foamy substance generated with the mixture of foaming catalyst and gas is eventually forced into the nozzle section 28 where it is mixed with the resin solution exiting the conduit 44 to thereby form the desired foamed polymeric resin. It follows that the space provided between the inside wall of the cylindrical tube 46 and the outer wall of the central conduit 44 provide a foaming chamber, indicated 50, for the foam gun 20, and it is within this space, or foaming chamber 50, that a filler material (e.g. glass beads or metal wool) can be positioned for enhancing the blend of the foaming catalyst and the gas flowing through the foaming chamber 50.

With reference still to FIG. 1, the nozzle section 28 includes a conically-shaped head 56 having a collar portion 58 adapted to threadably accept the discharge end of the cylindrical tube 46 and a tubular discharge portion 68 joined to the collar portion 58 by way of a tapered mid-portion 60. The collar portion 58 is preferably sealed about the discharge end of the tube 46 with tapered threads 59, although an O-ring can be used with straight threads.

Mounted at opposite ends of the central conduit 44 are perforated screens 61, 62 (FIG. 1) which are each captured between a pair of threaded pipe bushings, which serve as collars, at the ends thereof. Each of the perforated screens 61 and 62 is provided with a plurality of apertures to permit the passage of foaming catalyst and gas (or the foamy mixture of foaming catalyst and gas) therethrough. Collectively and as will be apparent herein, the screens 61, 62 confine the filler material (e.g. glass beads or metal wool) which has been positioned within the foaming chamber 50 to enhance the mixture of foaming catalyst and gas routed therethrough.

The discharge end of the conduit 44 terminates at a spray tip 70 through which the resin solution is discharged in a spray pattern within the nozzle section head 56 for mixing of the resin solution with the foamy substance generated with the foaming catalyst and gas. Although a detailed description of the spray tip 70 and its componentry is not believed to be necessary, suffice it to say that the spray tip 70 includes a metering orifice of a size and shape to provide a hollow cone spray of resin within the mixing chamber for mixing with the foamy mixture of foaming catalyst and gas flowing through the head 56 of the nozzle section 28 so that the desired foamed polymeric resin is discharged through the discharge portion 68 of the nozzle section head 56. For a more complete description of a spray tip suitable for use in the foam gun 20, reference can be had to U.S. Pat. No. 4,213,936, the disclosure of which is incorporated herein by reference.

It is a feature of the foam gun 20 that its monitoring means 23 and its adjustable valving means 25 are associated with the manifold section 26 for enabling an operator to monitor the flow rate of each liquid foam-producing ingredient delivered to the foam gun 20 at the foam gun 20 and for enabling the operator to make adjustments, as needed, to the flow rate of each foam-producing ingredient delivered to the foam gun 20 at the gun 20. To this end, the monitoring means 23 includes two flow meters 82 and 84 which are each connected in flow communication with a corresponding one of the passageways 34 and 36 so that the flow rate of the liquid ingredients (i.e. the foaming catalyst and resin solution) entering the corresponding passageway 34 or 36 can be continually monitored. Each flow meter 82 or 84 has a display 86 which is adapted to provide the operator with a continuous readout of the flow rate of the liquid foam-producing ingredient entering the corresponding passageway 34 or 36 and, as is the case with the depicted foam gun 20, is preferably a digital flow meter whose display 86 is a digital display comprised of multiple groups of LEDs or LCDs. Such multiple groups of LEDs or LCDs of one flow meter 84 is indicated 90a-90c in FIG. 1 and are arranged in the conventional 7-segment configuration to generate number characters.

As far as the control of the air flow rate to the foam gun 20 is concerned, there is provided a needle valve 158 (FIG. 1) associated with the source 52 of pressurized air (e.g. an air compressor disposed remotely of the gun 20). To select a desirable air flow rate from the source 52, an amount of foam is generated with the gun 20 and weighed. Applicant has determined through emperical evidence that the weight of one square foot of fresh foam containing a desirable amount of air weighs between 2.5 and 3.0 pounds. Consequently and if during the air flow selection method, the fresh foam generated with the gun 20 weighs less than 2.5 pounds, the amount of air conducted from the compressed air source is decreased to reduce the amount of air in the resulting foam mixture. Conversely, if the fresh foam generated with the gun 20 weighs more than 3.0 pounds, the amount of air conducted from the compressed air source is increased to increase the amount of air in the resulting foam mixture. It follows that the desired air flow to the gun 20 is selected through somewhat of a trial and error process. However, such a selection process is not particularly time-consuming, since such a selection process is typically performed the beginning of each day's work, and it is not common to make further adjustments to the air flow rate throughout the day.

With reference still to FIGS. 1 and 2, the adjustable valving means 25 includes two separately-adjustable manually-operable valves 96 and 98 which are each joined in flow communication with a corresponding one of the passageways 34 and 36 of the manifold section head 30 so that the flow rate of each liquid foam-producing ingredient entering the corresponding passageway 34 or 36 can be incrementally adjusted. Each valve 96 and 98 includes a body 100 through which a corresponding foam-producing ingredient is permitted to flow and a valve device (e.g. the needle of a needle valve) is mounted internally of the body 100 for movement relative to the body 100 into an out of the flow path of the ingredient moving through the body 100. The position of the valve device relative to the body 100 can be altered by manually rotating a knob 102 supported by the body 100 and operatively connected to the valve device mounted internally of the body 100 so that by manually rotating the knob 102 in one or the opposite rotational direction relative to the body 100, the valve device bodily moves into and out of the flow path of the corresponding flow-producing ingredient flowing through the body 100 to thereby alter the flow rate of the ingredient moving through the body 100.

Unlike a shut-off valve which can only be used to alter the flow rate of a fluid flowing therethrough between a fully open and a fully closed condition, each valve 96 or 98 enables an operator to adjust the flow rate of fluid (i.e. a foam-producing ingredient) therethrough between a number of possible flow rates. In other words, by rotating a knob 102 of any of the valves 96 and 98 relative to its corresponding valve body in one rotational direction or the opposite rotational direction by an incremental amount, the flow rate of liquid permitted to flow through the valve 96 or 98 is adjusted by a corresponding, or incremental, amount. It follows that each valve 96 or 98 provides means by which the flow of each liquid foam-producing ingredient introduced to the foam gun 20 by way of the manifold section 24 can be controllably regulated between two rates for accurately controlling the foam-producing ingredients to the foam gun 20.

As best shown in FIG. 1, each valve 96 or 98 is connected alongside a corresponding flow meter 82 or 84 to form an assembly 112 or 114 therewith, and each formed assembly 112 or 114 is joined in-line with a corresponding passageway 34 or 36 of the head 30 of the manifold section 26. Therefore, each liquid foam-producing ingredient which enters its corresponding passageway 34 or 36 must initially flow through the meter 82 or 84 and then through the valve 96 or 98 before flowing into the passageway 34 or 36.

Because the flow monitoring means 23 and the flow adjustable valving means 25 are incorporated within the foam gun 20, an operator who operates the foam gun 20 need not return to the sources of the resin solution or foaming catalyst in order to check or make necessary adjustments to the flow rates of the liquid ingredients flowing to the foam gun 20. Such an advantage can be readily appreciated when compared to the conventional foam-generating and injecting systems in which the sources of foam-producing ingredients (i.e. resin solution, foaming catylst and compressed gas) are commonly stationed at a stationary location, indicated 120 in FIG. 1, (such as a parked truck) from which the foam-producing ingredients are delivered, or pumped, to the foam gun 20 by way of flexible hoses, and any flow-monitoring or devices for controlling the flow of the various liquid foam-producing ingredients to the foam gun could only be checked and altered, if necessary, at the stationary location. Consequently, each time that the flow of the liquid foam-producing ingredients is desired to be monitored and/or adjusted in these conventional system, the foam gun had to be carried back to the stationary location (e.g. the parked truck). Such an act, of course, is burdensome and time-consuming. By incorporating the flow monitoring means 23 and adjustable valving means 25 within the foam gun 20, a foam gun operator can monitor the flow rates of the various ingredients and make adjustments, if necessary, without having to carry the foam gun 20 back to the parked truck.

Further still and because the adjustable valving means 25 are connected in relatively close flow proximity to the hollow interior 38 of the head 30 of the manifold section 26, any adjustment of the valves 96 and 98 of the adjustable valving means 25 results in a prompt adjustment of the flow rate of the liquid foam-producing ingredients entering the head 30. This is in sharp contrast to making an adjustment in the flow rate of a flow-producing ingredient with a flow control-related device disposed remotely of (flow-wise) the foam gun (such as at a parked truck) which necessarily results in a delayed response in the ingredient flow rate at the foam gun.

Furthermore, because the adjustable valving means 25 of the foam gun 20 enables the flow rate of each liquid foam-producing ingredient to the manifold section head 30 to be adjusted in small increments, the flow of the various foam-producing ingredients can be selected with a high degree of accuracy, and the foam gun 20 is further advantageous in this respect. One more advantage provided by the present invention relates to the size of the flexible hoses used to conduct each foam-producing ingredient to the foam gun 20 in relation to the volumetric flow rates of the ingredients involved. More specifically, the internal volume of the flexible hoses joining each source of foam-producing ingredient is relatively large in relation to the volumetric flow rates of the ingredient flowing into the foam gun 20, so that as long as adjustments are made to the volumetric flow rates of the various foam-producing ingredients remote of the foam gun, the flexible hoses provide, in effect, a reservoir which could permit seepage of the foam-producing ingredients to flow into the foam gun unchecked. Because the flow control valves 96, 98 of the depicted foam gun 20 are situated in relatively close proximity to the hollow interior 38 of the manifold section 26, there is no unwanted seepage of liquid foam-producing ingredients into the hollow interior 38 of the manifold section 26 upon adjustment of the flow or shut-off of the flow of foam-producing ingredients into the foam gun 20 by way of the valves 96 and 98.

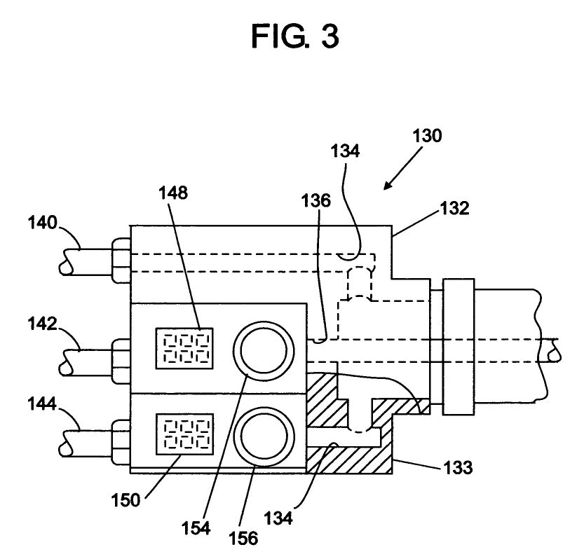

It will be understood that numerous modifications and substitutions can be had to the aforedescribed embodiment without departing from the spirit of the invention. For example, although the aforedescribed apparatus 20 has been shown and described as including a manifold section 26 to which flow meters 82 and 84 and manually-operable valves 96 and 98 are directly connected, an apparatus in accordance with the principles of the present invention can include a manifold section within which flow meters and flow control valves are integrally mounted. For example, there is illustrated in FIGS. 3 and 4 an alternative embodiment, generally indicated 130, of a foam gun having a manifold section 132 having a body 133 which defines interior passageways 134, 136 and 138 connectable, respectively, to sources of resin solution, foaming catalyst and gas (e.g. air) by way of hoses 140, 142 and 144. Mounted within the body of the manifold section 132 are two sets of digital flow meters 148 and 150 and two manually-operable (e.g. needle) valves 154 and 156 for monitoring and controlling the flow of the liquid foam-producing ingredients to the foam gun 130. Each flow meter 148 or 150 is matched with a corresponding valve 154 or 156 to form a meter/valve assembly, and each matched meter/valve assembly is joined in-line with a corresponding passageway 136 or 138 so that the flow rate of each liquid foam-producing ingredient conducted through the passageways can be readily monitored and accurately controlled at the foam gun 130.

Accordingly, the aforedescribed embodiment 20 is intended for the purpose of illustration and not as limitation.

1. In an apparatus for generating and injecting a foamed polymeric resin formed by a mixture of foam-producing ingredients delivered to the apparatus wherein the foam-producing ingredients include liquid ingredients and wherein the apparatus includes a manifold section through which the foam-producing ingredients are introduced to the apparatus through separate conduits, the improvement comprising:
means for monitoring the flow of at least one liquid foam-producing ingredient introduced to the manifold section of the apparatus; and
adjustable valving means for controllably regulating the flow of the at least one liquid foam-producing ingredient into the manifold section between two preselected flow rates, each of the monitoring means and the adjustable valving means being associated with the manifold section of the apparatus so that the flow of the at least one liquid foam-producing ingredient introduced to the manifold section can be monitored and controlled at the apparatus.

2. The improvement as defined in claim 1 wherein the monitoring means includes a flow meter connected to the manifold section for monitoring the flow rate of the at least one liquid foam-producing ingredient flowing into the apparatus.

3. The improvement as defined in claim 1 wherein the manifold section includes passageways through which the liquid foam-producing ingredients are permitted to enter the apparatus through the separate conduits and the monitoring means includes flow meters connected to the manifold section for measuring the flow rate of each liquid foam-producing ingredient which enters the apparatus through the passageways thereof.

4. The improvement as defined in claim 3 wherein each of the flow meters is a digital flow meter.

5. The improvement as defined in claim 1 wherein the adjustable valving means includes a valve connected to the manifold section for controlling the flow rate of the at least one liquid foam-producing ingredient flowing into the apparatus.

6. The improvement as defined in claim 5 wherein the manifold section includes passageways through which each liquid foam-producing ingredient is introduced to the apparatus, and the adjustable valving means includes a manually-operable valve associated with each of the manifold section passageways so that the flow rate of the liquid foam-producing ingredient flowing through each passageway can be controlled with a corresponding needle valve.

7. The improvement as defined in claim 1 wherein the manifold section includes an interior within which two of the foam-producing ingredients are permitted to mix with one another and wherein the two foam-producing ingredients includes a liquid foam-producing ingredient, and the adjustable valving means includes a manually-operable valve for controlling the flow of the liquid foam-producing ingredient which is permitted to enter the interior of the manifold section.

8. The improvement as defined in claim 1 wherein the manifold section includes passageways through which the foam-producing ingredients are introduced to the apparatus from the separate conduits and the monitoring means includes flow meters connected to the manifold section for measuring the flow rate of each liquid foam-producing ingredient which enters the passageways thereof, and the adjustable valving means includes a plurality of manually-operable valves connected to the manifold section so that each valve can be used to control the flow rate of a corresponding liquid foam-producing ingredient introduced to the apparatus through the manifold section thereof.

9. The improvement as defined in claim 8 wherein each of the manually-operable valves is a needle valve.

10. In an apparatus for generating and spraying a foamed polymeric resin formed by a mixture of foam-producing ingredients delivered to the apparatus from sources of foam-producing ingredients disposed remotely of the apparatus wherein the foam-producing ingredients include liquid foam-producing ingredients and wherein the apparatus includes a manifold section through which the foam-producing ingredients are introduced to the apparatus and within which at least two of the foam-producing ingredients are permitted to be mixed with one another, the improvement comprising:
means for monitoring the flow of at least one liquid foam-producing ingredient delivered to the manifold section of the apparatus; and
adjustable valving means for controllably regulating the flow of the at least one liquid foam-producing ingredient into the manifold section between two preselected flow rates, each of the monitoring means and the adjustable valving means being located in relatively close proximity to the manifold section of the apparatus for monitoring and accurately controlling the flow of the at least one liquid foam-producing ingredient introduced to the manifold section during operation of the apparatus.

11. The improvement as defined in claim 10 wherein the monitoring means and the adjustable valving means are connected to the manifold section for measuring the flow of the at least one liquid foam-producing ingredient as the ingredients are introduced to the manifold section.

12. The improvement as defined in claim 10 wherein the manifold section includes passageways through which the foam-producing ingredients are introduced to the apparatus and the monitoring means and the adjustable valving means are connected in-line with the passageways of the manifold section for measuring the flow of the liquid foam-producing ingredients conducted through the passageways.

13. The improvement as defined in claim 10 wherein each of the manifold section includes passageways through which the foam-producing ingredients are permitted to enter the apparatus through the separate conduits and the monitoring means includes flow meters connected to the manifold section for measuring the flow rate of each liquid foam-producing ingredient which enters the apparatus through the passageways thereof.

14. The improvement as defined in claim 13 wherein each of the flow meters is a digital flow meter.

15. The improvement as defined in claim 14 wherein the manifold section includes passageways through which each liquid foam-producing ingredient is introduced to the apparatus, and the adjustable valving means includes a manually-operable valve associated with each of the manifold section passageways so that the flow rate of the liquid foam-producing ingredient flowing through each passageway can be controlled with a corresponding needle valve.

16. The improvement as defined in claim 10 wherein the manifold section includes passageways through which the liquid foam-producing ingredients are introduced to the apparatus from the sources of foam-producing ingredients and the monitoring means includes flow meters connected to the manifold section for measuring the flow rate of each liquid foam-producing ingredient which enters the passageways thereof, and the adjustable valving means includes a plurality of manually-operable valves connected to the manifold section so that each valve can be used to control the flow rate of a corresponding liquid foam-producing ingredient introduced to the apparatus through the manifold section thereof.

17. The improvement as defined in claim 16 wherein each of the manually-operable valves is a needle valve.

18. A foam generating and injecting apparatus to which foam-producing ingredients are introduced for producing a foamed polymeric resin within the apparatus and wherein the foam-producing ingredients include liquid foam-producing ingredients, the apparatus comprising:
an elongated body including means defining passageways through which each liquid foam-producing ingredient is separately introduced to the apparatus and a nozzle section at the opposite end of the body through which the generated foamed resin is discharged from the apparatus;
a flow meter associated with each of the passageways for monitoring the flow rate of each liquid foam-producing ingredient entering the apparatus; and
a manually-operable valve associated with each of the passageways enabling an operator to accurately control the flow rate of each liquid foam-producing ingredient entering the apparatus.

19. The apparatus as defined in claim 18 wherein each of the flow meters is a digital flow meter.

20. The apparatus as defined in claim 18 wherein each of the manually-adjustable valves is a needle valve.

21. The apparatus as defined in claim 18 wherein one of the foam-producing ingredients is compressed air which is introduced to the apparatus for producing foam with the liquid foam-producing ingredients and wherein the air is conducted to the apparatus from a compressed air source, and there is associated with the compressed air source a needle valve for controlling the flow rate of compressed air to the apparatus.
